(19) United States
(12) Patent Application Publication
(10) Pub. No.: US 2010/0278982 A1
(43) Pub. Date: Nov. 4, 2010

(54) Method for Modifying the pH of Meat Products to Improve the Qaulity Thereof

(75) Inventors: Ranzell Nickelson, II, Fort Worth, TX (US); Kyle Pfeiffer, Aledo, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(73) Assignee: EDGE Food Products, LLC, Forth Worth, TX (US)

(21) Appl. No.: 12/637,982

(22) Filed: Dec. 15, 2009

Related U.S. Application Data
(60) Provisional application No. 61/173,655, filed on Apr. 29, 2009.

(51) Int. Cl. A23L 1/227; A23L 1/314; A23L 1/318

(52) U.S. Cl. 426/281; 426/650; 426/534

(57) ABSTRACT

A method of increasing the moisture content of a meat product by infusing a basic amino acid pH modifying substance into the meat product. The basic amino acid pH modifying substance can be the amino acid arginine which has been treated to adjust the pH of the arginine within a selected range. The treated arginine is then infused into meat product in order to neutralize lactic acid present in the meat as a result of glycolysis, to thereby maintain the pH at levels closer to a physiological state. The addition of the specially treated arginine to the meat product acts to adjust the pH of the meat product upwardly with a consequent rise in the pH of the meat product being treated from a pH of around 5.6 to a pH of about 6.0 or greater.

### CROSS-REFERENCE TO RELATED APPLICATION

The present application claims priority from earlier filed provisional application Ser. No. 61/173,655, filed Apr. 29, 2009, entitled “Infusion Plus,” by inventor Ranzell Nickelson, II.

### BACKGROUND OF THE INVENTION

1. Field of the Invention

The present invention generally relates to food processing techniques in which fluids are infused into a meat product and, more specifically, to a method for improving the quality of meat products by infusing a pH altering substance into the meat product.

2. Description of the Prior Art

Moisture retention is critical to the enjoyable taste and eating quality of meat products. Bound water helps maintain flavor and increases the tenderness of the meat product. However, the bound water content of meat changes over time. When oxygen stops flowing to the muscle, glycogen which is stored in the muscle is converted to lactic acid through the process known as glycolysis. The lactic acid causes the pH of the meat to decrease from about 6.0 or above to about 5.6. This drop in pH has a deleterious effect on the meat's ability to retain water.

This process can be explained chemically in terms of the isoelectric point of the muscle protein during glycolysis. The “isoelectric point”, (hererin IEP), is the pH at which a particular molecule or surface carries no net electric charge. For example, amphoteric molecules called zwitterions contain both positive and negative charges depending on the functional groups present in the molecule. The net charge on the molecule is affected by the pH of the surrounding environment and can become more positively or negatively charged due to the loss or gain of protons (H⁺). The IEP is the pH value at which the molecule carries no electrical charge or the negative and positive charges are equal.

Biological amphoteric molecules such as proteins contain both acidic and basic functional groups. Amino acids which make up proteins may be positive, negative, neutral or polar in nature, and together give a protein its overall charge. At a pH below their IEP, proteins carry a net positive charge; above their IEP they carry a net negative charge. Generally speaking, as the pH of the meat product moves toward the isoelectric point of the muscle protein (5.0) as during glycolysis, the charges on the proteins lose their ability to bind water. The loss of a meat product's ability to bind water has a number of deleterious effects on the meat product. First and foremost, the lean meat cab become tough to chew and can lose flavor.

In order to counteract the changes in meat products which occur during glycolysis, a number of foreign substances have been added to meat in the past, during processing operations, to improve its moisture content. However, these foreign substances, sometimes in the form of chemical additives, often cause the meat product to quickly lose its organoleptic qualities (the qualities of foods affecting the sensory organs, i.e. taste, color, odor, feel, etc.). Sometimes these qualities are also called the “mouth feel”. For example, processed meat may look gray or white, may have a grainy feel to the tongue, may ooze fluids, or the like, any one or more of which might make it psychologically unappetizing.

Another complicating factor facing the food processor in today's business environment is the fact that, especially in the case of food products for human consumption, the foods must conform to and pass many governmental regulations. These regulations can add to the difficulty in processing meat products in the simplest and most economical fashion, because many of the most practical processes may be restricted or forbidden by the applicable regulations. For example, in many cases, the food processor is forbidden from adding food coloring to the meat, which may result in a product on the shelf with a resulting color suggesting spoiled food. For these and other reasons, the more natural the food processing technique involved, usually the better. The use of more natural ingredients results in a food label which is much “friendlier” as opposed to the use of similar processes involving the use of, for example, phosphates, hydrocolloids and ammonium hydroxide.

Certain of the known meat processing operations in use today have as their particular object to effect a change in the pH of the meat products by adding appropriate pH modifying substances. However, the techniques utilized have often involved “unfriendly” additives. For example, U.S. Pat. No. 5,871,795 discloses a process for modifying the pH of meat products using pH modifying gases, particularly ammonia gas and carbon dioxide gas, for the purpose of reducing microbe counts in the meat products. The pH modification disclosed in this patent is accomplished by placing the pH modifying gas in contact with the surface of the meat product at a pressure above the vapor pressure of the gas at the temperature of the meat product.

U.S. Pat. Nos. 6,387,426 and 6,142,067 both disclose other processes for applying a pH increasing materials to meat. In each case, the pH modifying material is ammonia or involves the use of ammonia.

Other meat processing techniques shown in the prior art references appear to involve the use of more natural ingredient, including amino acids such as arginine. For example, U.S. Pat. No. 3,681,095 teaches that arginine and like amino acids can be infused into meat before it is dehydrated so that it will have a more juicy flavor upon re-hydration. However, the '095 patent teaches that the pH of the injection liquid should be relatively low, preferably between 6-10, most preferably about 8. Also, the reference does not teach modifying the arginine prior to infusion.

U.S. Pat. No. 3,001,875 describes a process for preparing a modified soy protein which apparently can be used to bind water in meat products and to emulsify fat. The composition is a water washed glycinin concentrate and is mixed with an edible agent and a base so that the pH has a value between about 6-10.5.

U.S. Pat. No. 3,552,978 describes a meat additive which improves the quality of meat-containing foods and can be applied by injection. However, the additive is typically used in a aqueous solution at a pH value below about 8 or even 7 (column 2, lines 23-26).

U.S. Pat. No. 5,780,039 describes a nutritional composition with improved taste which has a low pH (less than about 7) in the form of an amino acid selected from among those including arginine.

U.S. Pat. No. 7,407,679 and Publ. No. 2008/0286427 both describe cationic preservatives which are used in food products and which can include esters of lauric acid and arginine.

Despite the advances in the food processing arts represented by these and other prior art references, a need continues to exist for a method for increasing the moisture content of meats in order to enhance the taste and other desirable qualities of the meat product.

A need also exists for such a method which utilizes a natural ingredient to provide the meat with a higher moisture content, rather than utilizing, for example, phosphates, hydrocolloids and ammonium hydroxide.

### SUMMARY OF THE INVENTION

The present invention has as its primary object to meet the aforesaid objectives by addressing many of the deficiencies in the prior art.

One object of the invention is, accordingly, to provide a method of increasing the moisture content of a meat product by using a more natural, friendlier processing aid than has been previously available.

Another object of the invention is to eliminate the necessity of elaborate technical procedures to control and monitor the preparation of the tenderizing solution, and further provide a solution that is safe and harmless in case of spills or skin contact in its administration.

Yet another object of the invention is to provide a method of tenderizing meat which eliminates the necessity of any special handling, such as freezing or low temperature holding of the tenderized meat by the packer, retailer or consumer.

Another object of the invention is to provide a method of tenderization of meat which would allow the retailer to process, package and display the tenderized meat in the usual manner for handling fresh meat.

A further object of the invention is to provide a method of tenderization of meat that allows the consumer to handle and cook the tenderized meat in the usual manner, as well as to cook the meat to any desired degree (rare, medium or well done) with less shrinkage and less loss of natural juices.

A further object of the invention is to provide a method of the aforementioned type which is simple to implement and which is economical in use.

The present invention involves the infusion of a “basic amino acid pH modifying substance” into a meat product in order to raise the pH of the meat product and thereby increase the moisture content of the meat product. As used in this disclosure and in the accompanying claims, a “basic amino acid pH modifying substance” may be any selected amino acid with a suitably adjusted pH that, when added to a meat product, results in a rise in the pH of the meat product being treated to within a defined range. This range will generally be from a pH of around 5.6 to a pH of around 6.0 or above. In the preferred case, the basic amino acid is a specially treated arginine which has been treated to deprotonate the amino acid to free H⁺ ions, with a consequent adjustment of the pH of the arginine within a selected range prior to infusion into the meat. The specially treated arginine is then infused into the meat in order to neutralize some of the lactic acid in the meat to maintain the pH at levels closer to a physiological state.

In one preferred case, a suitable base such as potassium hydroxide is added to the arginine to deprotonate it (free H⁺ ions) and to thereby achieve a pH of around 11.6. The arginine is added to a brine solution and infused into meat. The higher pH of the infusion solution restores the pH of the meat product to allow the meat protein to bind more water. Changing the pH of the meat from, for example, from 5.6 to 6.0 and above, increases the meat's ability to hold water. A second probable mode of action concerns the reaction of the H⁺ ions which result from the deprotonation of arginine with the carboxyl group (COO) found on the end of amino acids that are the building blocks of meat proteins. These two mechanisms of pH buffering and hydrogen bonding, associated with the specially modified arginine of the invention, contribute to a juicier and more tender meat product. Arginine is also generally recognized as being the most hydrophilic of the 20 basic amino acids and can hold water through hydrogen bonding. Because arginine is a weak base and hydrophilic, it is especially well suited for use in the method of the invention.

The method of the invention thus encompasses injecting or forcing an arginine treatment solution, as described herein into the interior of a meat product. Adding the arginine-based pH modifying substance into the interior of the meat product preferably raises the pH at one or more points within the interior of the meat product to a pH of at least about 6.0. A treatment solution of the arginine treated with a suitable base is infused into the meat without recirculation of the treatment solution. The solution can be injected into meat at levels in the range from about 10-20% by weight. Subprimal portions of meat are injected with a chilled solution to a desired pump level. The treatment solution can be added to ground meat at in the range from about 6-8% by weight, prior to forming into patties. For ground beef, the solution is added directly by pouring it into the final meat processing blender prior to forming the patties, rather than using an injection technique. The resulting meat is more tender, juicy and flavorful.

In essence, the combination of arginine and potassium hydroxide are used as processing aids to control the pH of the brine solution which is being infused into the meat. However, the treatment method of the invention differs from using either arginine or potassium hydroxide alone. The use of potassium hydroxide alone is unacceptable, since potassium hydroxide is a strong base and dissociation becomes too rapid. By using a combination of arginine and potassium hydroxide, as previously described, a weak base reaction is created that allows the meat to re-adjust to a higher physiological pH which will hold more moisture.

Additional objects, features and advantages will be apparent in the written description which follows.

### BRIEF DESCRIPTION OF THE DRAWINGS

FIG. 1A is a structural formula of the basic amino acid arginine which is used as a starting material in practicing the method of the invention; and

FIG. 1B illustrates the structural formula of the specially modified arginine which comprises the basic amino pH modifying substance used in the practice of the invention.

### DETAILED DESCRIPTION OF THE INVENTION

As outlined in the Summary of the Invention, this invention concerns a composition and method for the tenderization of meat of freshly slaughtered animal carcasses, meat cuts, chilled carcasses or cold meat cuts. A special pH modifying solution is infused into the meat being treated to obtain a significant improvement in tenderness, taste and juiciness. The invention is intended primarily for use with beef, veal, pork, lamb, poultry, seafood and other meats used for human consumption which are referred to collectively herein as “meat products.”

Of the several sensory characteristics of meat, tenderness is perhaps the trait most highly desired by consumers. Consequently, meat tenderness is a factor of major economic importance to the livestock and meat industries. Much effort has been expended in attempting to improve the tenderness of meat through the breeding, feeding and management of meat animals. For example, in order to assure tenderness, meat animals have traditionally been fed on high energy or grain diets for extensive periods of time. It would be preferably, in many cases, if alternative methods were available to this traditional method of achieving tenderness. These alternative techniques will be referred to in the discussion which follows generically as “meat processing” operations.

Meat processing operations include a wide variety of processing steps for preparing meat products for consumers. After slaughter, the animal carcass is cleaned, chilled, and then passed on to trimming operations in which large cuts of meat such as steaks, roasts, and filets are separated from the carcass. Special processing steps may be applied to the substance left after the initial trimming operations to recover additional lean meat from the trimmings. Applicant's have discovered that the incorporation or injection of various concentrations of an aqueous solution of a basic amino acid pH modifying substance into meat cuts or chilled carcasses or meat cuts results in a substantial and highly significant increase in tenderness of the meat.

As used in this disclosure in the accompanying claims, a “basic amino acid pH modifying substance” may be any selected amino acid with a suitably adjusted pH that, when added to a meat product, produces a consequent increase in the pH of the meat product being treated to within a selected range. Generally speaking, the desired pH of the treated meat product will be greater than about 5.6, preferably greater than about 6.0.

The tendering solutions in our invention are prepared simply by dissolving the appropriate amount or weight of the basic pH modifying substance in water or brine, so that the concentration of the pH modifying substance in the solution is of the molarity desired with respect to the total volume of the solution. Either distilled water or RO water may be used as the solvent. The tendering solutions may be prepared immediately prior to use, or prepared in advance and stored at room temperature or in a refrigerator.

The tendering solutions may be introduced or injected into the meat by any suitable means, such as through known multi-needle injection devices equipped with multi-apertured needles. Injection pressure does not appear to be a critical element, but rather the objective is to obtain a uniform distribution of the tendering mixture in the meat tissue. The tendering solutions are harmless to plant personnel, create no particular meat handling problems for the packers, retailer, or consumer, and are easily controlled as they do not necessarily need to be altered according to the breed, sex, age or grade of the animal from which the meat is obtained, as is usually the case when proteolytic enzymes are used as tenderizers. The tendering solutions may be injected into the meat in varying amounts. We have tested injection amounts ranging from about 10-20% by weight of the meat to be treated. Vacuum tumbling may be another means of applications.

The preferred basic amino acid pH modifying substance used in the practice of the invention is arginine. Arginine is a basic amino acid. The L-form is one of the twenty most common natural amino acids. The IUPAC name is 2-amino-5-(diaminomethylidene-amino) pentanoic acid. The molecular formula for arginine is C₆H₁₄N₄O₂ and the molar mass is 174.2 g mol⁻¹. The amino acid side chain of arginine consists of a 4-carbon aliphatic straight chain, the distal end of which is capped by a complex guanidinium group. With a pKₐ of 12.48, the guanidinium group is positively charged in neutral, acidic and even most basic environments, and thus imparts basic chemical properties to arginine. Because of the conjugation between the double bond and the nitrogen lone pairs, the positive charge is delocalized, enabling the formation of multiple H-bonds.

Arginine is therefore preferred for purposes of the practice of the method of the present invention due to the following factors, among others:

It is one of the 20 most common amino acids;
It is semi-essential;
With a pKa of 12.48, it is positively charged in neutral, acidic and even most basic environments;
Beef is a natural source of arginine;
It is recognized as being GRAS as a nutrient and dietary supplement;
Amino acids with polar R groups that form hydrogen bonds to water are classified as hydrophilic;
Arginine has a hydropathy index of −4.5, the most hydrophilic of the 20 amino acids; and
The acid/base properties of the alpha-amino group in an amino acid are very similar to the properties of ammonia and the ammonium ion which has bee used in the past to raise the meat pH.

It will be understood by those skilled in the relevant art, that the term “arginine” is intended to encompass arginine and any of its well known variants. Table 1 below presents an index of the well known variants.

TABLE 1

| | |
|---|---|
| ARG | ARGININE |
| ARG_LEO2 | L-ARGININE C-TERMINAL DEPROTONATED FRAGMENT |
| ARG_LEO2H | L-ARGININE C-TERMINAL PROTONATED FRAGMENT |
| ARG_LEO2H_DHH12 | L-ARGININE C-TERMINAL PROTONATED FRAGMENT/WITH SIDE CHAIN |
| | DEPROTONATED NH1 |
| ARG_LEO2H_DHH22 | L-ARGININE C-TERMINAL PROTONATED FRAGMENT/WITH SIDE CHAIN |
| | DEPROTONATED NH2 |
| ARG_LEO2H_RHN1 | L-ARGININE C-TERMINAL PROTONATED FRAGMENT/SIDE CHAIN |
| | RESONANCE ALTERNATE |
| ARG_LEO2_DHH12 | L-ARGININE C-TERMINAL DEPROTONATED FRAGMENT/WITH SIDE |
| | CHAIN DEPROTONATED NH1 |
| ARG_LEO2-DHH22 | L-ARGININE C-TERMINAL DEPROTONATED FRAGMENT/WITH SIDE |
| | CHAIN DEPROTONATED NH2 |
| ARG_LEO2_RNH1 | L-ARGININE C-TERMINAL DEPROTONATED FRAGMENT/SIDE CHAIN |
| | RESONANCE ALTERNATE |
| ARG_LFOH | L-ARGININE FREE NEUTRAL |
| ARG_LFOH_DHH12 | L-ARGININE FREE NEUTRAL/WITH SIDE CHAIN DEPROTONATED NH1 |
| ARG_LFOH_DHH22 | L-ARGININE FREE NEUTRAL/WITH SIDE CHAIN DEPROTONATED NH2 |
| ARG_LFOH_RNH1 | L-ARGININE FREE NEUTRAL/SIDE CHAIN RESONANCE ALTERNATE |
| ARG_LFZW | L-ARGININE FREE ZWITTERION |
| ARG_LFZW_DHH12 | L-ARGININE FREE ZWITTERION/WITH SIDE CHAIN DEPROTONATED NH1 |
| ARG_LFZW_DHH22 | L-ARGININE FREE ZWITTERION/WITH SIDE CHAIN DEPROTONATED NH2 |
| ARG_LFZW_RNH1 | L-ARGININE FREE ZWITTERION/WITH CHAIN RESONANCE ALTERNATE |
| ARG_LL | L-ARGININE - LINKING EMBEDDED FRAGMENT |
| ARG_LL_DHH12 | L-ARGININE - LINKING EMBEDDED FRAGMENT/WITH SIDE CHAIN |
| | DEPROTONATED NH1 |
| ARG_LL-DHH22 | L-ARGININE - LINKING EMBEDDED FRAGMENT/WITH SIDE CHAIN |
| | DEPROTONATED NH2 |
| ARG_RNH1 | L-ARGININE - LINKING EMBEDDED FRAGMENT/SIDE CHAIN |
| | RESONANCE ALTERNATE |
| ARG_LSN3 | L-ARGININE N-TERMINAL PROTONATED FRAGMENT |
| ARG_LSN3_DHH12 | L-ARGININE N-TERMINAL PROTONATED FRAGMENT/WITH SIDE CHAIN |
| | DEPROTOMATED NH1 |
| ARG_LSN3_DHH22 | L-ARGININE N-TERMINAL PROTONATED FRAGMENT/WITH SIDE CHAIN |
| | DEPROTOMATED NH2 |
| ARG_LSN3_RNH1 | L-ARGININE N-TERMINAL PROTONATED FRAGMENT/SIDE CHAIN |
| | RESONANCE ALTERNATE |

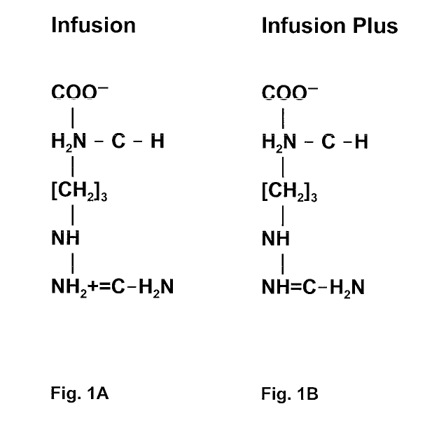

As previously discussed, the basic amino acid arginine is specially treated in the practice of the invention so that it exists in the form of a weak base. FIG. 1A shows the basic amino acid arginine prior to treatment with a base. FIG. 1B shows the specially treated arginine which has been treated with potassium hydroxide to deprotonate the molecule and produce the “basic amino acid pH modifying substance” which is useful for the purposes of the present invention.

Once the arginine has been treated with a suitable base, the treated arginine is typically added to water or brine to form a treatment solution and is then “infused” into the meat product to be treated. By the term “infusion” is meant injection, as by a needle, into a cut of meat, or in the case of ground beef, physically blending the treatment solution with the meat in a blender. In the first case, a meat product treatment method according to the invention therefore includes inserting an injection conduit or needle into a meat product so that an opening or other fluid communication structure associated with the injection conduit is positioned within the interior of the meat product. Once the injection conduit is properly positioned within the interior of the meat product, the desired basic amino acid pH modifying substance may be forced through the injection conduit and into the interior of the meat product through the fluid communication structure. Alternatively to openings such as those in hypodermic needles, the fluid communication structure associated with the injection conduit may include one or more sections of porous and permeable substance through which the desired treatment solution may flow in response to a suitable driving pressure.

Once the basic amino acid pH modifying substance is injected into the interior of the meat product, the meat product may be physically manipulated to help distribute the pH modifying substance within the meat product. This manipulation may comprise increasing the pressure on the surfaces of the meat product or tumbling or massaging the meat product in a suitable device. The insertion and removal of the injection conduits also provide some manipulation to the meat product.

It will be appreciated that the amount of pH modifying substance required to produce the desired final pH in the meat product will depend upon a number of factors including the concentration of the pH modifying substance, the initial pH of the meat product, and the temperature of the meat product, In our laboratory tests, we have varied the concentration of the specially treated arginine whether used individually or in combination with other of the known processing aids from about 0.001 molar to about 1.0 molar. It is pointed out that while concentrations of the chemical compounds below the lower limits as stated above produce some tenderizing effect, the effect is not as dramatic as would seem to be desired by consumers. In addition, concentrations of the chemical compounds higher than the upper limits as stated above resulted in further increases in tenderness, but the tenderness increase produced by these higher limits does not appear to be enough to justify the added costs; moreover, the natural meat flavor may in some cases to be affected by these higher limits.

The following examples are intended to be illustrative of the principles of the present invention without being limiting in the scope thereof:

Applicant's experiments started with 100 grams of 93% lean ground beef and 100 ml of distilled water. The meat and water were blended for 15 seconds and then filtered through a paper filter for 15 minutes. The weight of filtrate was recorded as “WHC.” The meat pH was 5.9 and the control yielded 32 g of WHC. A comparison was made with ammonium hydroxide with a pH or 9.5 which produced a WHC of 3 g. Comparisons were also run with lysine, glutamine and arginine. Arginine had the least filtrate and produced a meat pH of 5.58.

Applicant's then developed what is referred to as a % ROC (Retention Over Control) as a means of taking out water pH and meat quality variables. The weight of water control minus weight of treatment divided by the weight of water control= % ROC.

The testing procedure was then changed to use 50 grams of meat for 100 ml of water. Different concentrations of arginine “R” were evaluated. The pHm (pH of meat) of the water control was 6.04 and WHC of 30. The pHm of ammonium hydroxide control was 6.56 and WHC of 25 for ROC of 17%. A 0.01 M solution of R had a pHm of 6.63 and WHC of 21 for ROC of 30%. As shown in Table 2 below, a 0.01 M solution of R appear to produce equivalent results to a 0.01 M solution of ammonium hydroxide.

TABLE 2

| Treatment | pH | pHm | WHC | % ROC |
|---|---|---|---|---|
| H₂O Control | | 6.14 | 12.6 | |
| NH₄ Control | | 6.40 | 11.6 | |
| H₂O Control | | 6.04 | 30 | |
| NH₄ Control .01 M | | 6.56 | 25 | 17 |
| .1 M R | | 9.14 | 7.7 | 74 |
| .05 M R | | 8.55 | 9.4 | 69 |
| .01 M R | | 6.63 | 21 | 30 |
| .005 M.R. | | 6.28 | 24 | 20 |

Table 3 below shows the results of trying different concentrations of R. It does not appear to be useful to use concentrations of R below 0.01 M.

TABLE 3

| Treatment | pH | pHm | WHC | % ROC |
|---|---|---|---|---|
| H₂O Control | 6.82 | 6.00 | 36.6 | |
| NH₄ Control | 10.55 | 6.44 | 19.7 | 46 |
| .002 M | 9.35 | 5.92 | 38.3 | — |
| .004 M | 9.55 | 6.05 | 32 | — |
| .006 M | 9.71 | 6.14 | 36.3 | — |
| .008 M | 9.75 | 6.26 | 28.2 | 23 |
| .01 M (24 hrs.) | 9.8 | 6.42 | 22.8 | 38 |
| .005 M (24 hrs.) | 9.73 | 6.17 | 37.2 | — |
| .01 M (new) | 10.41 | 6.42 | 23.2 | 36 |
| .005 M (new) | 10.2 | 6.20 | 23.6 | 35.5 |

Experiments were then conducted to compare lysine as an addition. As shown in Table 4 below, the addition of lysine reduced the ROC due to a lowering of the solution pH (10.4 to 9.4).

TABLE 4

| Treatment | pH | pHm | WHC | % ROC | |
|---|---|---|---|---|---|
| H₂O Control | | 6.3 | 30.4 | — | Check STD |
| NH₄ (.01 M) | 10.3 | 6.44 | 29.6 | 2.6 | |
| 2% R (2 g/l) | 10.4 | 6.9 | 19.6 | 35.5 | |
| 2% R | 10.4 | 6.9 | 18.5 | 39.1 | |
| .2% R + Lysine + | 9.4 | | 21.1 | 30.5 | Try Alanine |
| NACL | | | | | |

Experiments were then run comparing the use of ascorbic acid, a 2% NaCl solution, a 2% R solution, and mixtures of R with ascorbic acid, NaCl and ammonium hydroxide. As shown in Table 5 below, a negative ROC resulted in some cases as the protein was too denatured to hold water.

TABLE 5

| Treatment | pH | pHm | WHC | % ROC |
|---|---|---|---|---|
| H₂O Control | 7.5 | 6.38 | 26.5 | 0 |
| 2% NaCl | 7.14 | 6.21 | 8.3 | 60 |
| 0.5 Ascorbic Acid | 3.3 | 5.05 | 38.3 | −44 |
| 0.2% R | 10.87 | 6.87 | 16.0 | 40 |
| 01.% R + 0.24 Ascorbic | 4.16 | 6.10 | 28.3 | −1.8 |
| 0.2% R + 1% NaCl | 10.40 | 6.96 | 16.8 | 37 |
| 0.2% R = 1% NaHCO₃ | 9.20 | 7.78 | 14.9 | 44 |

Table 6 which follows shows the results achieved by the addition of 2% NaCl to a 2% solution of R. The % ROC increased from 29 to 95.

TABLE 6

| Treatment | pH | pHm | WHC | % ROC |
|---|---|---|---|---|
| H₂O Control | | 6.27 | 29.7 | 0% |
| H₂O Control | 8.00 | 6.34 | 33.3 | |
| .2% R | 10.90 | 6.94 | 20.0 | 29% |
| .2% R | 10.90 | 6.87 | 24.6 | |
| 0.2% R + NaCl | 10.50 | 6.80 | 1.2 | 95% |
| 0.2% R + NaCl | 10.50 | 6.72 | 2.0 | |

Table 7 which follows is a comparison of different bases which were used to treat the arginine. Potassium hydroxide has a pKa of 0.5, whereas calcium hydroxide as a pKa of 2.43. Potassium hydroxide is much more soluble and is also GRAS approved. A proposed potassium hydroxide concentration of 0.0006605 M appears acceptable to “activate” R.

TABLE 7

| | 2.43 pKa | 0.2 pKa | 0.5 pKa |
|---|---|---|---|
| | CaOH | NaOH | KOH |
| 1 M | 12.77 | 13.75 | 13.63 |
| .1 M | 12.24 | 12.94 | 12.90 |
| .01 M | 11.65 | 11.99 | 11.99 |
| .001 M | 10.91 | 11.00 | 11.00 |

Table 8 which follows is a comparison of a solution of R and R++ to a 0.2% solution of sodium tri-phosphate (STP). The ROC for R++ was 40% compared to 36% for STP. R represents the original arginine treated with 0.0006605 molar KOH, while R++ is treated with twice the concentration of KOH.

TABLE 8

| Treatment | pH | pHm | WHC | % ROC |
|---|---|---|---|---|
| H₂O Control | 8.60 | 6.05 | 19.3 | |
| R | 10.49 | 6.85 | 10.9 | 44 |
| R++ | 11.02 | 7.22 | 11.6 | 40 |
| STP (0.2%) | 11.30 | 6.48 | 12.3 | 36 |

The above test results demonstrate that the basic amino acid pH modifying substances of the invention can be used to achieve meat moisture levels which are commensurate with those obtained through the use of ammonium hydroxide. The use of the specially modified arginine is a much “friendlier” processing aid than ammonium hydroxide or such additives as phosphates, hydrocolloids, and the like and makes for a friendlier, “clean” label on the product. Infusion of the treatment solutions of the invention into the meat can also have the beneficial effect of causing a reduction in surface bacteria.

While the invention has been shown in only one of its forms, it is not thus limited but is susceptible to various changes and modifications without departing from the spirit thereof.

What is claimed is:

1. A method for treating meat products, the method comprising the steps of:
infusing the meat product with a basic amino acid pH modifying substance in order to increase the tenderness, flavor and juiciness of the meat product by increasing the moisture content of the meat product;
wherein the basic amino acid pH modifying substance is a selected amino acid with a suitably adjusted pH such that, when added to a meat product, acts as a weak base with a consequent rise in the pH of the meat product being treated from a pH of around 5.6 to a pH of at least 6.0 or above.

2. The method of claim 1, wherein the basic amino acid pH modifying substance is the amino acid arginine which has been treated to adjust the pH of the arginine within a selected range, the treated arginine then being infused into the meat product in order to neutralize lactic acid present in the meat product as a result of glycolysis, to thereby maintain the pH of the meat product at levels closer to a physiological state.

3. The method of claim 2, wherein the pH of the arginine is adjusted by the addition of a base, the pH of the arginine being adjusted from a pH of 10.6 to 11.8.

4. The method of claim 3, wherein the base which is used is potassium hydroxide (KOH).

5. The method of claim 2, wherein the basic amino acid pH modifying substance is added to a brine solution which is then infused into the meat product, the arginine being present in the brine solution in a concentration of about 0.0056% by weight of the meat being treated.

6. The method of claim 2, wherein in the case of subprimal cuts of meat, the infusion method further comprises the steps of:
(a) inserting an injection conduit into a meat product so that a fluid communication structure of the injection conduit is positioned within an interior of the meat product; and
(b) forcing the basic amino acid pH modifying substance through the injection conduit and the fluid communication structure into the interior of the meat product.

7. The method of claim 2, wherein the infusion method in the case of ground beef further comprises the steps of:
physically manipulating the meat product to distribute the basic amino acid pH modifying substance within the meat product by adding the basic amino acid pH modifying substance in a blending step, prior to forming the ground beef into patties.

8. A meat tendering composition for use by injection into a meat product, the composition comprising:
an injectable aqueous solution of a basic amino acid pH modifying substance in an amount sufficient to measurably improve the tenderness, flavor and juiciness of the meat product;
wherein the basic amino acid pH modifying substance is a selected amino acid with a suitably adjusted pH such that, when added to a meat product, acts as a weak base to thereby produce a consequent rise in the pH of the meat product being treated from a pH of around 5.6 to a pH of at least 6.0 or above.

9. The meat tenderizing composition of claim 8, wherein the basic amino acid pH modifying substance is the amino acid arginine which has been treated to deprotonate the amino acid and free H⁺ ions, thereby adjusting the pH of the arginine within a selected range, the treated arginine then being infused into the meat product in order to neutralize lactic acid present in the meat product as a result of glycolysis, to thereby maintain the pH at levels closer to a physiological state.

10. The meat tenderizing composition of claim 9, wherein the pH of the arginine is adjusted by the addition of a base, the pH of the arginine adjusted to about 11.8.

11. The meat tenderizing composition of claim 10, wherein the base which is used is potassium hydroxide.

12. The meat tenderizing composition of claim 11, wherein the basic amino acid pH modifying substance is added to a brine solution which is then infused into the meat product, the arginine being present in the brine solution in a concentration of about 0.0056% by weight of the meat being treated.
